(19) United States
(12) Patent Application Publication
(10) Pub. No.: US 2011/0065819 A1
(43) Pub. Date: Mar. 17, 2011

(54) ELASTIC MOLDED FOAM BASED ON POLYOLEFIN/STYRENE POLYMER MIXTURES

(75) Inventors: Carsten Schips, Speyer (DE); Klaus Hahn, Kirchheim (DE); Georg Grässel, Ludwigshafen (DE); Daniela Longo-Schedel, Sankt Augustin (DE); Jens Assmann, Mannheim (DE); Andreas Gietl, Mannheim (DE); Konrad Knoll, Mannheim (DE); Holger Ruckdäschel, St. Martin (DE); Maximilian Hofmann, Mannheim (DE); Christof Zylla, Limburgerhof (DE); Jürgen Lambert, Gommersheim (DE); Geert Janssens, Friedelsheim (DE)

(73) Assignee: BASF SE Patents, Trademarks and Licenses, Ludwigshafen (DE)

(21) Appl. No.: 12/921,526

(22) PCT Filed: Mar. 12, 2009
(86) PCT No.: PCT/EP2009/052920

§ 371 Date: Nov. 23, 2010

(30) Foreign Application Priority Data
Mar. 13, 2008 (EP) 08152693.1
Dec. 30, 2008 (EP) 08173084.8
Dec. 30, 2008 (EP) 08173086.3
Dec. 30, 2008 (EP) 08173087.1
Mar. 5, 2009 (EP) 09154432.0

(51) Int. Cl. C08J 9/16

(52) U.S. Cl. 521/59

(57) ABSTRACT

Expandable, thermoplastic polymer bead material, comprising
A) from 45 to 98.8 percent by weight of a styrene polymer,
B1) from 1 to 45 percent by weight of a polyolefin whose melting point is in the range from 105 to 140° C.,
B2) from 0 to 25 percent by weight of a polyolefin whose melting point is below 105° C.,
C1) from 0.1 to 9.9 percent by weight of a styrene-butadiene block copolymer,
C2) from 0.1 to 9.9 percent by weight of a styrene-ethylene-butylene block copolymer,
D) from 1 to 15 percent by weight of a blowing agent,
E) from 0 to 5 percent by weight of a nucleating agent
   where the entirety of A) to E) gives 100% by weight, and also processes for production of the same, and use for the production of elastic molded-foam moldings.

The invention relates to expandable, thermoplastic polymer bead materials, comprising
A) from 45 to 97.8 percent by weight of a styrene polymer,
B1) from 1 to 45 percent by weight of a polyolefin whose melting point is in the range from 105 to 140° C.,
B2) from 0 to 25 percent by weight of a polyolefin whose melting point is below 105° C.,
C1) from 0.1 to 25 percent by weight of a styrene-butadiene block copolymer,
C2) from 0.1 to 10 percent by weight of a styrene-ethylene-butylene block copolymer,
D) from 1 to 15 percent by weight of a blowing agent,
E) from 0 to 5 percent by weight of a nucleating agent
   where the entirety of A) to E) gives 100% by weight, and also processes for production of the same, and use for the production of elastic molded-foam moldings.

Polystyrene foams are rigid foams. For many applications the low elasticity is a disadvantage, an example being the packaging sector, because they cannot provide adequate protection of the packaged product from impact, and the foam moldings used as packaging fracture when subject to even slight deformation, removing the ability of the foam to protect from any subsequent load. There have therefore been previous attempts to increase the elasticity of polystyrene foams.

Expandable polymer mixtures composed of styrene polymers and of polyolefins and, if appropriate, of solubility promoters, such as hydrogenated styrene-butadiene block copolymers, are known by way of example from DE 24 13 375, DE 24 13 408 or DE 38 14 783. The foams obtainable therefrom are intended to have better mechanical properties than foams composed of styrene polymers, in particular better elasticity and lower brittleness at low temperatures, and also resistance to solvents, such as ethyl acetate and toluene. However, the ability of the expandable polymer mixtures to retain blowing agent, and their foamability, to give low densities, are inadequate for processing purposes.

WO 2005/056652 describes molded-foam moldings whose density is in the range from 10 to 100 g/l, obtainable via fusion of prefoamed foam bead material composed of expandable, thermoplastic polymer pellets. The polymer pellets comprise mixtures composed of styrene polymers and of other thermoplastic polymers, and can be obtained via melt impregnation and subsequent pressurized underwater pelletization.

There are also known elastic molded foams composed of expandable interpolymer bead materials (e.g. US 2004/0152795 A1). The interpolymers are obtainable via polymerization of styrene in the presence of polyolefins in aqueous suspension, and form an interpenetrating network composed of styrene polymers and of olefin polymers. However, the blowing agent diffuses rapidly out of the expandable polymer bead materials, and it therefore has to be stored at low temperature, and is sufficiently foamable only for a short period.

WO 2008/050909 describes elastic molded foams composed of expanded interpolymer particles having a core-shell structure, where the core is composed of a polystyrene-polyolefin interpolymer and the shell is composed of a polyolefin. These molded foams have improved elasticity and resistance to cracking when compared with EPS, and they are mainly used as transport packaging or as energy absorber in automobile applications.

WO 2005/092959 describes nanoporous polymer foams which are obtainable from multiphase polymer mixtures comprising blowing agent, the dimensions of the domains of these being from 5 to 200 nm. It is preferable that the domains are composed of a core-shell particle obtainable via emulsion polymerization, where the solubility of the blowing agent in these is at least twice as high as in the adjacent phases.

WO 2008/125250 has described a new class of thermoplastic molded foams with cells whose average cell size is in the range from 20 to 500 μm, in which the cell membranes have a nanocellular or fibrous structure with pore diameters or fiber diameters below 1500 nm.

The known foams that are resistant to cracking, for example those composed of expanded polyolefins, of expanded interpolymers, or of expandable interpolymers, generally have no, or poor, compatibility with prefoamed, expandable polystyrene (EPS) beads. Poor fusion of the different foam beads is often found when these materials are processed to give moldings, such as foam slabs.

It was an object of the present invention to provide expandable, thermoplastic polymer bead materials with low blowing-agent loss and high expansion capability, where these can be processed to give molded foams with high stiffness together with good elasticity, and also to provide a process for their production.

A further intention was that the expandable, thermoplastic polymer bead materials be compatible with conventional expandable polystyrene (EPS) and capable of processing to give molded foams which have high compressive strength and high flexural strength, and also high energy absorption, together with markedly improved elasticity, resistance to cracking, and bending energy.

The expandable thermoplastic polymer bead materials described above have accordingly been found.

The invention also provides the foam beads P1 obtainable via prefoaming of the expandable, thermoplastic polymer bead materials, and the molded foams obtainable via subsequent sintering by hot air or steam.

The expandable, thermoplastic polymer bead materials preferably comprise:
A) from 55 to 89.7 percent by weight, in particular from 55 to 78.1 percent by weight, of a styrene polymer,
B1) from 4 to 25 percent by weight, in particular from 7 to 15 percent by weight of a polyolefin whose melting point is in the range from 105 to 140° C.,
B2) from 1 to 15 percent by weight, in particular from 5 to 10 percent by weight, of a polyolefin whose melting point is below 105° C.,
C1) from 1 to 15 percent by weight, in particular from 6 to 9.9 percent by weight, of a styrene-butadiene block copolymer,
C2) from 1 to 9.9 percent by weight, in particular from 0.8 to 5 percent by weight, of a styrene-ethylene-butylene block copolymer,
D) from 3 to 10 percent by weight of a blowing agent,
E) from 0.3 to 3 percent by weight, in particular from 0.5 to 2 percent by weight, of a nucleating agent,
   where the entirety composed of A) to E) gives 100% by weight.

The expandable, thermoplastic polymer bead materials are particularly preferably composed of components A) to E). In the foam beads obtainable therefrom via prefoaming, the blowing agent (component D) has substantially escaped during the prefoaming process.

Component A

The expandable thermoplastic polymer bead materials comprise from 45 to 97.8% by weight, particularly preferably from 55 to 78.1% by weight, of a styrene polymer A), such as standard polystyrene (GPPS) or impact-resistant polystyrene (HIPS), or styrene-acrylonitrile copolymers (SAN), or acrylonitrile-butadiene-styrene copolymers (ABS) or a mixture thereof. The expandable thermoplastic polymer bead materials used to produce the foam beads P1 preferably comprise standard polystyrene (GPPS) as styrene polymer A). Particular preference is given to standard polystyrene grades whose weight-average molar masses are in the range from 120 000 to 300 000 g/mol, in particular from 190 000 to 280 000 g/mol, determined by gel permeation chromatography and whose melt volume rate MVR (200° C./5 kg) to ISO 1133 is in the range from 1 to 10 cm³/10 min, examples being PS 158 K, 168 N or 148 G from BASF SE. To improve the fusion of the foam bead materials during processing to give the molding, it is possible to add free-flowing grades, such as Empera® 156L (Innovene).

Components B

The expandable thermoplastic polymer bead materials comprise, as components B), polyolefins B1) whose melting point is in the range from 105 to 140° C., and polyolefins B2) whose melting point is below 105° C. The melting point is the melting peak determined by means of DSC (dynamic scanning calorimetry) at a heating rate of 10° C./minute.

The expandable, thermoplastic polymer bead materials comprise from 1 to 45 percent by weight, in particular from 4 to 35% by weight, particularly preferably from 7 to 15 percent by weight, of a polyolefin B1). The polyolefin B1) used preferably comprises a homo- or copolymer of ethylene and/or propylene whose density is in the range from 0.91 to 0.98 g/L (determined to ASTM D792), in particular polyethylene. Polypropylenes that can be used are in particular injection-molding grades. Polyethylenes that can be used are commercially obtainable homopolymers composed of ethylene, e.g. LDPE (injection-molding grades), LLDPE, or HDPE, or copolymers composed of ethylene and propylene (e.g. Moplen® RP220 and Moplen® RP320 from BaseII or Versify® grades from Dow), ethylene and vinyl acetate (EVA), ethylene acrylate (EA), or ethylene-butylene acrylates (EBA). The melt volume index MVI (190° C./2.16 kg) of the polyethylenes is usually in the range from 0.5 to 40 g/10 min, and the density is usually in the range from 0.91 to 0.95 g/cm³. Blends with polyisobutene (PIB) can also be used (e.g. Oppanol® B150 from BASF SE). It is particularly preferable to use LLDPE whose melting point is in the range from 110 to 125° C. and whose density is in the range from 0.92 to 0.94 g/L.

Other suitable components B1) are olefin block copolymers composed of a polyolefin block PB1 (hard block) and of a polyolefin block PB2 (soft block), for example those described in WO 2006/099631. The polyolefin block PB1 is preferably composed of from 95 to 100% by weight of ethylene. The PB2 block is preferably composed of ethylene and α-olefin, and α-olefins that can be used here are styrene, propylene, 1-butene, 1-hexene, 1-octene, 4-methyl-1-pentene, norbornenes, 1-decene, 1,5-hexadiene, or a mixture thereof. A preferred PB2 block is an ethylene-α-olefin copolymer block having from 5 to 60% by weight of α-olefin, in particular an ethylene-octene copolymer block. Preference is given to multiblock copolymers of the formula (PB1-PB2)n, where n is a whole number from 1 to 100. The blocks PB1 and PB2 form in essence a linear chain and preferably have alternated or random distribution. The proportion of the PB2 blocks is preferably from 40 to 60% by weight, based on the olefin block copolymer. Particular preference is given to olefin block copolymers having alternating, hard PB1 blocks and soft, elastomeric PB2 blocks, these being commercially available as INFUSE®.

Ability to retain blowing agent increases markedly with a relatively small proportion of polyolefin B1). The shelf life of the expandable, thermoplastic polymer bead materials and their processability are therefore markedly improved. In the range from 4 to 20% by weight of polyolefin, expandable thermoplastic polymer bead material with long shelf life are obtained, with no impairment of the elastic properties of the molded foam produced therefrom. This is apparent by way of example in a relatively low compression set εₛₑₜ in the range from 25 to 35%.

The expandable, thermoplastic polymer bead materials comprise, as polyolefin B2), from 0 to 25 percent by weight, in particular from 1 to 15% by weight, particularly preferably from 5 to 10 percent by weight, of a polyolefin B2) having a melting point below 105° C. The density of the polyolefin B2) is preferably in the range from 0.86 to 0.90 g/L (determined to ASTM D792). Thermoplastic elastomers based on olefins (TPO) are particularly suitable for this purpose. Particular preference is given to ethylene-octene copolymers, which are obtainable commercially by way of example as Engage® 8411 from Dow. When expandable thermoplastic polymer bead materials which comprise component B2) have been processed to give foam moldings they exhibit a marked improvement in bending energy and ultimate tensile strength.

Components C

It is known from the sector of multiphase polymer systems that most polymers are immiscible or only sparingly miscible with one another (Flory), the result therefore being demixing to give the respective phases as a function of temperature, pressure, and chemical constitution. If incompatible polymers are linked to one another covalently, the demixing does not occur at the macroscopic level but only at the microscopic level, i.e. on the scale of the length of the individual polymer chain. The term used in this case is therefore microphase separation. The result is a wide variety of mesoscopic structures, e.g. lamellar, hexagonal, cubic, and bicontinuous morphologies, closely related to lyotropic phases.

For controlled establishment of the desired morphology, compatibilizers (components C) are used. According to the invention, an improvement in compatibility is achieved via the use of a mixture of styrene-butadiene block copolymers or styrene-isoprene block copolymers as component C1) and styrene-ethylene-butylene block copolymers (SEBS) as component C2).

Even small amounts of the compatibilizers lead to better adhesion between the polyolefin-rich and the styrene-polymer-rich phase, and markedly improve the elasticity of the foam, in comparison with conventional EPS foams. Studies of the domain size of the polyolefin-rich phase showed that the compatibilizer stabilizes small droplets via reduction of surface tension at the interface.

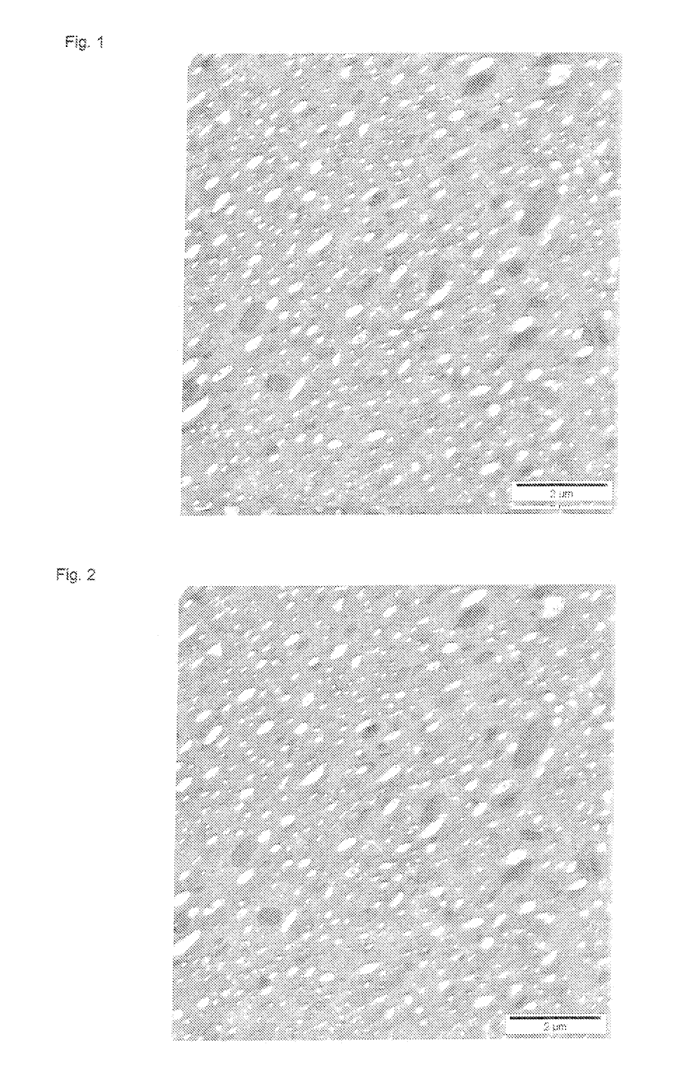

FIG. 1 shows an electron micrograph of a section through an expandable polystyrene/polyethylene which has disperse polyethylene domains in the polystyrene matrix and which comprises blowing agent.

It is particularly preferable that the expandable, thermoplastic polymer bead materials are composed of a multiphase polymer mixture which comprises blowing agent and which has at least one continuous phase, and at least two disperse phases K1 and K2 distributed within the continuous phase, where

a) the continuous phase consists essentially of component A,

b) the first disperse phase K1 consists essentially of components B1 and B2, and
c) the second disperse phase K2 consists essentially of component C1.

Component C2) preferably forms a phase boundary between the disperse phase K1 and the continuous phase.

By virtue of this additional disperse phase, it is possible to keep the domain size of the disperse phase at <2 μm, when the proportion of soft phase is relatively high. This leads to relatively high bending energy in the molded foam, for the same expandability.

The entirety of components C1) and C2) in the expandable, thermoplastic polymer bead materials is preferably in the range from 3.5 to 30 percent by weight, particularly preferably in the range from 6.8 to 18 percent by weight.

The ratio by weight of the entirety composed of components B1) and B2) to components C2) in the expandable, thermoplastic polymer bead materials is preferably in the range from 5 to 70.

The ratio by weight of components C1) to C2) in the expandable, thermoplastic polymer bead materials is preferably in the range from 2 to 5.

FIG. 2 shows an electron micrograph of a section through an expandable polystyrene/polyethylene which comprises blowing agent and which has a disperse polyethylene domain (pale regions) and a disperse styrene-butadiene block copolymer phase (dark regions) in the polystyrene matrix.

The expandable thermoplastic polymer bead materials comprise, as component C1), from 0.1 to 25 percent by weight, preferably from 1 to 15 percent by weight, in particular from 6 to 9.9 percent by weight, of a styrene-butadiene block copolymer or styrene-isoprene block copolymer.

Examples of materials suitable for this purpose are styrene-butadiene block copolymers or styrene-isoprene block copolymers. Total diene content is preferably in the range from 20 to 60% by weight, particularly preferably in the range from 30 to 50% by weight, and total styrene content is correspondingly preferably in the range from 40 to 80% by weight, particularly preferably in the range from 50 to 70% by weight.

Examples of suitable styrene-butadiene block copolymers composed of at least two polystyrene blocks S and of at least one styrene-butadiene copolymer block S/B are the star-branched block copolymers described in EP-A 0654488.

Other suitable materials are block copolymers having at least two hard blocks S₁ and S₂ composed of vinylaromatic monomers, and having, between these, at least one random soft block B/S composed of vinylaromatic monomers and diene, where the proportion of the hard blocks is above 40% by weight, based on the entire block copolymer, and the 1,2-vinyl content in the soft block B/S is below 20%, these being described in WO 00/58380.

Other suitable compatibilizers are linear styrene-butadiene block copolymers whose general structure is S-(S/B)-S having one or more (S/B)_{random} blocks which have random styrene/butadiene distribution, between the two S blocks. Block copolymers of this type are obtainable via anionic polymerization in a non-polar solvent with addition of a polar cosolvent or of a potassium salt, as described by way of example in WO 95/35335 or WO 97/40079.

The vinyl content is the relative proportion of 1,2 linkages of the diene units, based on the total of the 1,2-, 1,4-cis, and 1,4-trans linkages. The 1,2-vinyl content in the styrene-butadiene copolymer block (S/B) is preferably below 20%, in particular in the range from 10 to 18%, particularly preferably in the range from 12 to 16%.

Compatibilizers preferably used are styrene-butadiene-styrene (SBS) three-block copolymers whose butadiene content is from 20 to 60% by weight, preferably from 30 to 50% by weight, and these may be hydrogenated or non-hydrogenated materials. These are marketed by way of example as Styroflex® 2G66, Styrolux® 3G55, Styroclear® GH62, Kraton® D 1101, Kraton® D 1155, Tuftec® H1043, or Europren® SOL T6414. They are SBS block copolymers with sharp transitions between B blocks and S blocks.

Other materials particularly suitable as component C1 are block copolymers or graft copolymers which comprise
a) at least one block S composed of from 95 to 100% by weight of vinylaromatic monomers and of from 0 to 5% by weight of dienes, and
b) at least one copolymer block (S/B)_{A} composed of from 63 to 80% by weight of vinylaromatic monomers and of from 20 to 37% by weight of dienes, with a glass transition temperature Tg_{A} in the range from 5 to 30° C.

Examples of vinylaromatic monomers that can be used are styrene, alpha-methylstyrene, ring-alkylated styrenes, such as p-methylstyrene or tert-butylstyrene, or 1,1-diphenylethylene, or a mixture thereof. It is preferable to use styrene.

Preferred dienes are butadiene, isoprene, 2,3-dimethylbutadiene, 1,3-pentadiene, 1,3-hexadiene, or piperylene, or a mixture of these. Particular preference is given to butadiene and isoprene.

The weight-average molar mass M_{w} of the block copolymer is preferably in the range from 250 000 to 350 000 g/mol.

It is preferable that the blocks S are composed of styrene units. In the case of polymers produced via anionic polymerization, the molar mass is controlled by way of the ratio of amount of monomer to amount of initiator. However, initiator can also be added repeatedly after monomer feed has been completed, the product then being a bi- or multimodal distribution. In case of polymers produced by a free-radical process, the weight-average molecular weight M_{w} is set by way of the polymerization temperature and/or addition of regulators.

The glass transition temperature of the copolymer block (S/B)_{A} is preferably in the range from 5 to 20° C. The glass transition temperature is affected by the comonomer constitution and comonomer distribution, and can be determined via Differential Scanning Calorimetry (DSC) or Differential Thermal Analysis (DTA), or calculated from the Fox equation. The glass transition temperature is generally determined using DSC to ISO 11357-2 at a heating rate of 20K/min.

The copolymer block (S/B)_{A} is preferably composed of from 65 to 75% by weight of styrene and from 25 to 35% by weight of butadiene.

Preference is given to block copolymers or graft copolymers which respectively comprise one or more copolymer blocks (S/B)_{A} composed of vinylaromatic monomers and of dienes having random distribution. These can by way of example be obtained via anionic polymerization using alkyllithium compounds in the presence of randomizers, such as tetrahydrofuran, or potassium salts. Preference is given to potassium salts, using a ratio of anionic initiator to potassium salt in the range from 25:1 to 60:1. Particular preference is given to cyclohexane-soluble alcoholates, such as potassium tert-butylamyl alcoholate, these being used in a lithium-potassium ratio which is preferably from 30:1 to 40:1. The result can be a simultaneous low proportion of 1,2-linkages of the butadiene units.

The proportion of 1,2-linkages of the butadiene units is preferably in the range from 8 to 15%, based on the entirety of 1,2-, 1,4-cis-, and 1,4-trans-linkages.

The weight-average molar mass M_{w} of the copolymer block (S/B)_{A} is generally in the range from 30 000 to 200 000 g/mol, preferably in the range from 50 000 to 100 000 g/mol.

However, random copolymers (S/B)_{A} can also be produced via free-radical polymerization.

In the molding composition, at room temperature (23° C.), the blocks (S/B)_{A} form a semi-hard phase which is responsible for the high ductility and ultimate tensile strain values, i.e. high tensile strain at low tensile strain rate.

The block copolymers or graft copolymers can also comprise
c) at least one homopolydiene (B) block or copolymer block (S/B)_{B} composed of from 1 to 60% by weight, preferably from 20 to 60% by weight, of vinylaromatic monomers and of from 40 to 99% by weight, preferably from 40 to 80% by weight, of dienes, with a glass transition temperature Tg_{B} in the range from 0 to −110° C.

The glass transition temperature of the copolymer block (S/B)_{B} is preferably in the range from −60 to −20° C. The glass transition temperature is affected by the comonomer constitution and comonomer distribution, and can be determined via Differential Scanning Calorimetry (DSC) or Differential Thermal Analysis (DTA), or calculated from the Fox equation. The glass transition temperature is generally determined using DSC to ISO 11357-2 at a heating rate of 20K/min.

The copolymer block (S/B)_{B} is preferably composed of from 30 to 50% by weight of styrene and from 50 to 70% by weight of butadiene.

Preference is given to block copolymers or graft copolymers which respectively comprise one or more copolymer blocks (S/B)_{B} composed of vinylaromatic monomers and of dienes having random distribution. These can by way of example be obtained via anionic polymerization using alkyllithium compounds in the presence of randomizers, such as tetrahydrofuran, or potassium salts. Preference is given to potassium salts, using a ratio of anionic initiator to potassium salt in the range from 25:1 to 60:1. The result can be a simultaneous low proportion of 1,2-linkages of the butadiene units.

The proportion of 1,2-linkages of the butadiene units is preferably in the range from 8 to 15%, based on the entirety of 1,2-, 1,4-cis-, and 1,4-trans-linkages.

However, random copolymers (S/B)_{B} can also be produced via free-radical polymerization.

The blocks B and/or (S/B)_{B} forming a soft phase can be uniform over their entire length, or can have been divided into sections of different constitution. Preference is given to sections using diene (B) and (S/B)_{B} which can be combined in various sequences. Gradients having continuously changing monomer ratio are possible, where the gradient can begin with pure diene or with a high proportion of diene and the proportion of styrene can rise as far as 60%. It is also possible to have two or more gradient sections in the sequence. Gradients can be generated by feeding a relatively large or relative small amount of the randomizer. It is preferable to set a lithium-potassium ratio greater than 40:1, or, if tetrahydrofuran (THF) is used as randomizer, to adjust the amount of THF to less than 0.25% by volume, based on the polymerization solvent. One alternative is simultaneous feed of diene and vinylaromatic at a rate which is slow, compared with the polymerization rate, where the monomer ratio is controlled appropriately for the desired constitution profile along the soft block.

The weight-average molar mass M_{w} of the copolymer block (S/B)_{B} is generally in the range from 50 000 to 100 000 g/mol, preferably in the range from 10 000 to 70 000 g/mol.

The proportion by weight of the entirety of all of the blocks S is in the range from 50 to 70% by weight, and the proportion by weight of the entirety of all of the blocks (S/B)_{A} and (S/B)_{B} is in the range from 30 to 50% by weight, based in each case on the block copolymer or graft copolymer.

It is preferable that there is a block S separating blocks (S/B)_{A} and (S/B)_{B} from one another.

The ratio by weight of the copolymer blocks (S/B)_{A} to the copolymer blocks (S/B)_{B} is preferably in the range from 80:20 to 50:50.

Preference is given to block copolymers having linear structures, particularly those having the following block sequence:

S₁-(S/B)_{A}-S₂ (triblock copolymers)

### S₁-(S/B)_{A}-S₂-(S/B)_{B}-S₃, or

S₁-(S/B)_{A}-S₂-(S/B)_{A}-S₃ (pentablock copolymers),
where each of S₁ and S₂ is a block S.

These feature a high modulus of elasticity of from 1500 to 2000 MPa, a high yield stress in the range from 35 to 42 MPa), and tensile strain at break above 30% in mixtures using a proportion of polystyrene above 80% by weight. In contrast, the tensile strain at break of commercial SBS block copolymers using this proportion of polystyrene is only from 3 to 30%.

Preference is given to triblock copolymers of the structure S₁-(S/B)_{A}-S₂ which comprise a block (S/B)_{A} composed of from 70 to 75% by weight of styrene units and from 25 to 30% by weight of butadiene units. The glass transition temperatures can be determined using DSC or from the Gordon-Taylor equation, and, for this constitution, in the range from 1 to 10° C. The proportion by weight of the blocks S1 and S2, based on the triblock copolymer, is in each case preferably from 30% to 35% by weight. The total molar mass is preferably in the range from 150 000 to 350 000 g/mol, particularly preferably in the range from 200 000 to 300 000 g/mol.

Particular preference is given to pentablock copolymers of the structure S₁-(S/B)_{A}-S₂-(S/B)_{A}-S₃, which comprise a block (S/B)_{A} composed of from 70 to 75% by weight of styrene units and from 25 to 30% by weight of butadiene units. The glass transition temperatures can be determined using DSC or from the Gordon-Taylor equation, and, for this constitution, in the range from 1 to 10° C. The proportion by weight of the blocks S₁ and S₂, based on the pentablock copolymer, is in each case preferably from 50% to 67% by weight. The total molar mass is preferably in the range from 260 000 to 350 000 g/mol. Because of the architecture of the molecule, it is possible here to achieve tensile strain at break values of up to 300% for a proportion of styrene which is above 85%.

The block copolymers A can moreover have a star-shaped structure which comprises the block sequence S₁-(S/B)_{A}-S₂-X-S₂-(S/B)_{A}-S₁, where each of S₁ and S₂ is a block S, and X is the moiety of a polyfunctional coupling agent. An example of a suitable coupling agent is epoxidized vegetable oil, for example epoxidized linseed oil or epoxidized soybean oil. The product in this case is a star having from 3 to 5 arms. It is preferable that the star-shaped block copolymers are composed of an average of two S₁-(S/B)_{A}-S₂ arms and of two S₃ blocks linked by way of the moiety of the coupling agent, and comprise predominantly the structure S₁-(S/B)_{A}-S₂-X(S₃)₂-S₂-(S/B)_{A}-S₁, where S₃ is a further S block. The molecular weight of the block S₃ should be smaller than that of the blocks S₁. The molecular weight of the block S₃ preferably corresponds to that of the block S₂.

These star-shaped block copolymers can by way of example be obtained via double initiation, where an amount I₁ of initiator is added together with the vinylaromatic monomers needed for the formation of the blocks S₁, and an amount I₂ of initiator is added together with the vinylaromatic monomers needed for the formation of the S₂ blocks and S₃ blocks, after completion of the polymerization of the (S/B)_{A} block. The molar ratio I₁/I₂ is preferably from 0.5:1 to 2:1, particularly preferably from 1.2:1 to 1.8:1. The star-shaped block copolymers generally have a broader molar mass distribution than the linear block copolymers. This gives improved transparency at constant flowability.

Block copolymers or graft copolymers composed of the blocks S₁(S/B)_{A}, and (S/B)_{B}, for example pentablock copolymers of the structure S₁-(S/B)_{A}-S₂-(S/B)_{A}, form a co-continuous morphology. There are three different phases combined here within one polymer molecule. The soft phase formed from the (S/B)_{B} blocks provides the impact resistance of the molding composition and can reduce crack propagation (crazing). The semi-hard phase formed from the blocks (S/B)_{A} is responsible for the high ductility and ultimate tensile strain values. The modulus of elasticity and yield stress can be adjusted by way of the proportion of the hard phase formed from the blocks S and, if appropriate, admixed polystyrene.

The expandable, thermoplastic polymer bead materials comprise, as component C2), from 0.1 to 10 percent by weight, preferably from 1 to 9.9% by weight, in particular from 0.8 to 5 percent by weight, of a styrene-ethylene-butylene block copolymer (SEBS). Examples of suitable styrene-ethylene-butylene block copolymers (SEBS) are those obtainable via hydrogenation of the olefinic double bonds of the block copolymers C1). Examples of suitable styrene-ethylene-butylene block copolymers are the commercially available Kraton® G grades, in particular Kraton® G 1650.

Component D

The expandable, thermoplastic polymer bead materials comprise, as blowing agent (component D), from 1 to 15 percent by weight, preferably from 3 to 10 percent by weight, based on the entirety of all of the components A) to E), of a physical blowing agent. The blowing agents can be gaseous or liquid at room temperature (from 20 to 30° C.) and at atmospheric pressure. Their boiling point should be below the softening point of the polymer mixture, usually in the range from −40 to 80° C., preferably in the range from −10 to 40° C. Examples of suitable blowing agents are halogenated or halogen-free, aliphatic C₃-C₈ hydrocarbons, or are alcohols, ketones, or ethers. Examples of suitable aliphatic blowing agents are aliphatic C₃-C₈ hydrocarbons, such as n-propane, n-butane, isobutane, n-pentane, isopentane, n-hexane, neopentane, cycloaliphatic hydrocarbons, such as cyclobutane and cyclopentane, halogenated hydrocarbons, such as methyl chloride, ethyl chloride, methylene chloride, trichlorofluoromethane, dichlorofluoromethane, dichlorodifluoromethane, chlorodifluoromethane, dichlorotetrafluoroethane, and mixtures of these. Preference is given to the following halogen-free blowing agents, isobutane, n-butane, isopentane, n-pentane, neopentane, cyclopentane, and mixtures of these.

Capability of retention of blowing agent after storage can be improved, and lower minimum bulk densities can be achieved, if, as is preferred, the blowing agent comprises a proportion of from 25 to 100 percent by weight, particularly preferably from 35 to 95 percent by weight, based on the blowing agent, of isopentane or cyclopentane. It is particularly preferable to use mixtures composed of from 30 to 98% by weight, in particular from 35 to 95% by weight, of isopentane, and from 70 to 2% by weight, in particular from 65 to 5% by weight, of n-pentane.

Surprisingly, despite the relatively low boiling point of isopentane (28° C.), and the relatively high vapor pressure (751 hPa) in comparison with pure n-pentane (36° C.; 562 hPa), markedly better capability for retention of blowing agent, and therefore increased storage stability, combined with better foamability to give low densities, are found in blowing agent mixtures with isopentane content of at least 30% by weight.

Suitable co-blowing agents are those with relatively low selectivity of solubility for the phase forming domains, examples being gases, such as CO₂, N₂, or noble gases. The amounts used of these, based on the expandable, thermoplastic polymer bead materials, are preferably from 0 to 10% by weight.

Component E

The expandable, thermoplastic polymer bead materials comprise, as component E, from 0 to 5 percent by weight, preferably from 0.3 to 3 percent by weight, of a nucleating agent, such as talc.

The multiphase polymer mixture can moreover receive additions of additives, nucleating agents, plasticizers, halogen-containing or halogen-free flame retardants, soluble or insoluble inorganic and/or organic dyes and pigments, fillers, or co-blowing agents, in amounts which do not impair domain formation and foam structure resulting therefrom.

Production Process

The polymer mixture having a continuous and at least one disperse phase can be produced via mixing of two incompatible thermoplastic polymers, for example in an extruder.

The expandable thermoplastic polymer bead materials of the invention can be obtained via a process of
a) producing a polymer mixture with a continuous and at least one disperse phase via mixing of components A) to C) and, if appropriate, E),
b) impregnating this mixture with a blowing agent D) and pelletizing them to give expandable thermoplastic polymer bead materials,
c) and pelletizing to give expandable, thermoplastic polymer bead materials via underwater pelletization at a pressure in the range from 1.5 to 10 bar.

The average diameter of the disperse phase of the polymer mixture produced in stage a) is preferably in the range from 1 to 2000 nm, particularly preferably in the range from 100 to 1500 nm.

In another embodiment, the polymer mixture can also first be pelletized, in stage b), and the pellets can then be post-impregnated in a stage c) in an aqueous phase under pressure and at an elevated temperature, using a blowing agent D), to give expandable thermoplastic polymer bead materials. These can then be isolated after cooling below the melting point of the polymer matrix, or can be obtained directly in the form of prefoamed foam bead material via depressurization.

Particular preference is given to a continuous process in which, in stage a), a thermoplastic styrene polymer A) forming the continuous phase, for example polystyrene, is melted in a twin-screw extruder, and to form the polymer mixture is mixed with a polyolefin B1) and B2) forming the disperse phase, and also with the compatibilizers C1) and C2) and, if appropriate, nucleating agent E), and then the polymer melt is conveyed in stage b) through one or more static and/or dynamic mixing elements, and is impregnated with the blowing agent D). The melt loaded with blowing agent can then be extruded through an appropriate die, and cut, to give foam sheets, foam strands, or foam bead material.

An underwater pelletization system (UWPS) can also be used to cut the melt emerging from the die directly to give expandable polymer bead materials or to give polymer bead materials with a controlled degree of incipient foaming. Controlled production of foam bead materials is therefore possible by setting the appropriate counterpressure and an appropriate temperature in the water bath of the UWPS.

Underwater pelletization is generally carried out at pressures in the range from 1.5 to 10 bar to produce the expandable polymer bead materials. The die plate generally has a plurality of cavity systems with a plurality of holes. A hole diameter in the range from 0.2 to 1 mm gives expandable polymer bead materials with a preferred average bead diameter in the range from 0.5 to 1.5 mm. Expandable polymer bead materials with a narrow particle size distribution and with an average particle diameter in the range from 0.6 to 0.8 mm lead to better filling of the automatic molding system following prefoaming, where the design of the molding has a relatively fine structure. This also gives a better surface on the molding, with smaller volume of interstices.

The resultant round or oval particles are preferably foamed to a diameter in the range from 0.2 to 10 mm. Their bulk density is preferably in the range from 10 to 100 g/l.

One preferred polymer mixture in stage a) is obtained via mixing of
A) from 45 to 97.8 percent by weight, in particular from 55 to 78.1% by weight, of styrene polymer,
B1) from 1 to 45 percent by weight, in particular from 4 to 25% by weight, of a polyolefin whose melting point is in the range from 105 to 140° C.,
B2) from 0 to 25 percent by weight, in particular from 5 to 10% by weight, of a polyolefin whose melting point is below 105° C.,
C1) from 0.1 to 25 percent by weight, in particular from 6 to 15% by weight, of a styrene-butadiene block copolymer or styrene-isoprene block copolymer,
C2) from 0.1 to 10 percent by weight, in particular from 0.8 to 3% by weight, of a styrene-ethylene-butylene block copolymer, and
E) from 0 to 5 percent by weight, in particular from 0.3 to 2% by weight, of a nucleating agent, and,
   in stage c), is impregnated with from 1 to 15% by weight, in particular from 3 to 10% by weight, of a blowing agent D), where the entirety composed of A) to E) gives 100% by weight and is pelletized in stage c).

In order to improve processability, the finished expandable thermoplastic polymer bead materials can be coated using glycerol esters, antistatic agents, or anticaking agents.

The resultant round or oval beads are preferably foamed to a diameter in the range from 0.2 to 10 mm. Their bulk density is preferably in the range from 10 to 100 g/l.

The fusion of the prefoamed foam beads to give the molding, and the resultant mechanical properties, are in particular improved via coating of the expandable thermoplastic polymer bead materials with a glycerol stearate. It is particularly preferable to use a coating composed of from 50 to 100% by weight of glycerol tristearate (GTS), from 0 to 50% by weight of glycerol monostearate (GMS), and from 0 to 20% by weight of silica.

The expandable, thermoplastic polymer bead materials P1 of the invention can be prefoamed by means of hot air or steam to give foam beads whose density is in the range from 8 to 200 kg/m³, preferably in the range from 10 to 80 kg/m³, in particular in the range from 10 to 50 kg/m³, and can then be used in a closed mold to give foam moldings. The processing pressure selected here is sufficiently low that a domain structure is preserved in the cell membranes, fused to give molded-foam moldings. The gauge pressure selected is usually in the range from 0.5 to 1.5 bar, in particular from 0.7 to 1.0 bar.

The resulting thermoplastic molded foams P1 preferably have cells whose average cell size is in the range from 50 to 250 μm, and they preferably have, in the cell walls of the thermoplastic molded foams a disperse phase oriented in the manner of fibers and having an average diameter in the range from 10 to 1000 nm, particularly preferably in the range from 100 to 750 nm.

Foam Beads P2

The foam beads P2 used can comprise foam beads which differ from the foamed beads P1 of the invention and which in particular are composed of styrene polymers or of polyolefins, such as expanded polypropylene (EPP), expanded polyethylene (EPE), or prefoamed, expandable polystyrene (EPS). It is also possible to use combinations of various foam beads. Thermoplastic materials are preferably used. It is also possible to use crosslinked polymers, for example radiation-crosslinked polyolefin foam beads.

The foam beads based on styrene polymers can be obtained via prefoaming of EPS using hot air or steam in a prefoamer, to the desired density. Final bulk densities below 10 g/l can be obtained here via one or more prefoaming processes in a pressure prefoamer or continuous prefoamer.

For production of insulation sheets with high thermal insulation capability, it is particularly preferable to use prefoamed, expandable styrene polymers which comprise athermanous solids, such as carbon black, aluminum, graphite, or titanium dioxide, in particular graphite whose average particle size is in the range from 1 to 50 μm particle diameter, in amounts of from 0.1 to 10% by weight, in particular from 2 to 8% by weight, based on EPS, these polymers being known by way of example from EP-B 981 574 and EP-B 981 575.

Foam beads P2 which are particularly heat- and solvent-resistant are obtained from expandable styrene polymers, for example α-methylstyrene-acrylonitrile polymers (AMSAN), e.g. α-methylstyrene-acrylonitrile copolymers or α-methylstyrene-styrene-acrylonitrile terpolymers, the production of which is described in WO 2009/000872. It is moreover possible to use foam beads P2 based on styrene-olefin interpolymers or on impact-modified styrene polymers, e.g. impact-resistant polystyrene (HIPS).

The process can also use comminuted foam beads composed of recycled foam moldings. To produce the molded foams of the invention, the comminuted foam recyclates can be used to an extent of 100% or, for example, in proportions of from 2 to 90% by weight, in particular from 5 to 25% by weight, based on the foam beads P2, together with virgin product, without any substantial impairment of strength and of mechanical properties.

The foam beads P2 can also comprise additives, nucleating agents, plasticizers, halogen-containing or halogen-free flame retardants, soluble or insoluble inorganic and/or organic dyes and pigments, or fillers, in conventional amounts.

Production of Molded Foams

The foam beads P1 obtainable from the thermoplastic polymer bead materials of the invention exhibit surprisingly good compatibility with the foam beads P2, and can therefore be fused with these. It is also possible here to use prefoamed beads of different density. To produce the molded foams of the invention, it is preferable to use foam beads P1 and P2 whose density is respectively in the range from 5 to 50 kg/m³.

According to one embodiment, the foam beads P1 and P2 can be mixed and sintered in a mold, using hot air or steam.

It is preferable that the mixture used is composed of from 10 to 99% by weight, particularly from 15 to 80% by weight, of foam beads P1, and from 1 to 90% by weight, particularly from 20 to 85% by weight, of foam beads P2.

In another embodiment, the foam beads P1 and P2 can be charged to a mold without any substantial mixing, and sintered using hot air or steam. By way of example, the foam beads P1 and P2 can be charged in one or more layers to a mold, and sintered using hot air or steam.

The alternative processes of the invention can create molded-foam moldings in many different ways, and can adapt their properties to the desired application. The quantitative proportions, the density, or else the color of the foam beads P1 and P2 in the mixture can be varied for this purpose. The result is moldings with unique property profiles.

By way of example, molding machines used for this purpose can be those suitable for the production of moldings with varying density distribution. These generally have one or more slider filaments which can be removed after charging of the different foam beads P1 and P2, or during the fusion process. However, it is also possible that one type of foam bead P1 or P2 is charged and fused, and that the other type of foam bead is then charged and fused with the existing subsection of the foam molding.

This method can also produce moldings, for example pallets for dispatch of unitized products, where, by way of example, the ribs or feet have been manufactured from foam beads P1 and the remainder of the molding has been manufactured from foam beads P2.

Because of the compatibility of the foam beads P1 and P2, the material can be considered as practically of a single type for recycling purposes, requiring no separation into the individual components.

Use of the expandable, thermoplastic polymer bead materials and molded foams of the invention.

Because the molded foams obtainable from the thermoplastic polymer bead materials of the invention have a property profile lying between molded foams composed of expanded polypropylene (EPP) and of expandable polystyrene (EPS), they are in principle suitable for the conventional applications of both types of foam.

Moldings composed of foam beads P2 are suitable for the production of furniture, of packaging materials, in the construction of houses, or in drywall construction or interior finishing, for example in the form of laminate, insulating material, wall element or ceiling element, or else in motor vehicles.

Their elasticity makes them particularly suitable for shock-absorbent packaging, as core material for motor-vehicle bumpers, for internal cladding in motor vehicles, as cushioning material, and also as thermal-insulation and sun-bedding material. The molded foams of the invention are particularly suitable for the production of packaging materials and of damping materials, or of packaging with improved resistance to fracture and to cracking.

The elasticity of the molded foams also makes them suitable as inner cladding of protective helmets, for example ski helmets, motorcycle helmets, or cycle helmets, for absorbing mechanical impacts, or in the sports and leisure sector, or as core materials for surfboards.

However, high levels of thermal insulation and of sound deadening also permit applications in the construction sector. Floor insulation usually uses foam sheets directly laid on the concrete floor. This is a particularly important factor in the case of underfloor heating systems, because of downward thermal insulation. Here, the hot-water pipes are laid into appropriate profiled regions of the foam sheets. A cement screed is spread on the foam sheets, and a wooden floor or a wall-to-wall carpet can then be laid on the screed. The foam sheets also act as insulation with respect to solid-borne sound.

The moldings are also suitable as core material for sandwich structures in ship building and aircraft construction, and in the construction of wind-energy systems, and vehicle construction. By way of example, they can be used for the production of motor-vehicle parts, such as trunk floors, parcel shelves, and side door cladding.

The composite moldings are preferably used for the production of furniture, of packaging materials, or in the construction of houses, or in drywall construction, or in the interior finishing, for example in the form of laminate, insulating material, wall element, or ceiling element. The novel composite moldings are preferably used in motor-vehicle construction, e.g. as door cladding, dashboards, consoles, sun visors, bumpers, spoilers, and the like.

Because elasticity and resistance to cracking are higher than in molded foams composed of expandable polystyrene (EPS), while compressive strength is simultaneously high, the foam beads P2 in particular are suitable for the production of pallets. To improve the durability of the pallets, these can, if appropriate, be adhesive-bonded to wood, plastic, or metal, or sheathed on all sides with a plastics foil, for example those composed of polyolefins or of styrene-butadiene block copolymers.

### EXAMPLES

### Starting Materials

Component A:

Polystyrene whose melt viscosity index MVI (200° C./5 kg) is 2.9 cm³/10 min (PS158K from BASF SE, M_{w}=280 000 g/mol, viscosity number VN 98 ml/g)

Component B:
B1.1: LLDPE (LL1201 XV, ExxonMobil, density 0.925 g/L, MVI=0.7 g/10 min, melting point 123° C.)
B2.1: Ethylene-octene copolymer (Engage® 8411 from Dow, density 0.880 g/L, MVI=18 g/10 min, melting point 72° C.)
B2.2: Ethylene-octene copolymer (Exact®, 210 from ExxonMobil, density 0.902 g/L, MVI=10 g/10 min, melting point 95° C.)

Component C:
C1.1: Styrolux® 3G55, styrene-butadiene block copolymer from BASF SE,
C1.2: Styroflex® 2G66, thermoplastic elastic styrene-butadiene block copolymer (STPE) from BASF SE,
C1.3: Styrene-butadiene block copolymer of structure S₁-(S/B)_{A}-S₂-(S/B)_{A}-S₁ (20-20-20-20-20% by weight), weight-average molar mass: 300 000 g/mol
C2.1: Kraton G 1650, styrene-ethylene-butylene block copolymer from Kraton Polymers LLC
C2.2: Kraton G 1652, stylene-ethylene-butylene block copolymer from Kraton Polymers LLC

Component D:

Blowing agent mixture composed of isopentane and n-pentane, the material used unless otherwise stated being pentane S (20% by weight of isopentane, 80% by weight of n-pentane).

Component E:

Talc (HP 320, Omyacarb)

Production of Block Copolymer C1.3

To produce the linear styrene-butadiene block copolymer C1.3, 5385 ml cyclohexane were used as initial charge in a double-walled 10 liter stainless-steel stirred autoclave with crossblade agitator, and were titrated to the endpoint at 60° C. using 1.6 ml of sec-butyllithium (BuLi), until a yellow color appeared, caused by the 1,1-diphenylethylene used as indicator, and then the following were admixed: 3.33 ml of a 1.4 M sec-butyllithium solution for initiation, and 0.55 ml of a 0.282 M potassium tert-amyl alcoholate (PTA) solution as randomizer. The amount of styrene (280 g of styrene 1) needed to produce the first S block was then added and polymerized to completion. The further blocks were attached, as appropriate for the stated structure and constitution, via sequential addition of the appropriate amounts of styrene or styrene and butadiene, in each case using complete conversion. To produce the copolymer blocks, styrene and butadiene were simultaneously added in a plurality of portions, and the maximum temperature was restricted to 77° C., by countercurrent cooling. For block copolymer K1-3, the amounts required were 84 g of butadiene 1 and 196 g of styrene 2 for the block (S/B)_{A}, 280 g of styrene 3 for the block S2, 84 g of butadiene B2 and 196 g of styrene 4 for the block (S/B)_{A}, and 280 g of styrene 5 for the block S₁.

The living polymer chains were terminated by adding 0.83 ml of isopropanol, and 1.0% of CO₂/0.5% of water, based on solid, was used for acidification, and a stabilizer solution (0.2% of Sumilizer GS and 0.2% of Irganox 1010, based in each case on solid) was added. The cyclohexane was evaporated in a vacuum drying oven.

The weight-average molar mass M_{w} of the block copolymer C1.3 is 300 000 g/mol.

Measurements on Foam Moldings

Various mechanical measurements were carried out on the moldings, in order to demonstrate the elastification of the foam.

Compression set εₛₑₜ of the foam moldings was determined to ISO 3386-1, from simple hysteresis for 75% compression (advance 5 mm/min). Compression set εₛₑₜ is the percentage proportion lost from the initial height of the compressed specimen after 75% compression. In the case of the inventive examples, a marked elastification was observed in comparison with straight EPS, and is discernible from very high resilience.

Compressive strength was determined for 10% compression to DIN-EN 826, and flexural strength was determined to DIN-EN 12089. The bending energy was determined from the values measured for flexural strength.

### Examples 1 to 3

Components A) to C) were melted at from 240 to 260° C./140 bar in a Leistritz ZE 40 twin-screw extruder, and talc was admixed as nucleating agent (component E) (see table 1). Pentane S (20% of isopentane, 80% of n-pentane), as blowing agent (component D), was then injected into the polymer melt, and was incorporated homogeneously into the polymer melt by way of two static mixers. The temperature was then reduced to from 180° to 195° C., by way of a cooler. After further homogenization by way of two further static mixers, the polymer melt was injected at from 200 to 220 bar, at 50 kg/h, through a pelletizing die whose temperature was controlled to from 240 to 260° C. (hole diameter was 0.6 mm, with 7 cavity systems×7 holes, or 0.4 mm hole diameter with 7 cavity systems×10 holes). The polymer strand was chopped by means of underwater pelletizer system (11-10 bar of underwater pressure at a water temperature of from 40° C. to 50° C.), giving minipellets loaded with blowing agent and having narrow particle size distribution (d′=1.1 mm for hole diameter 0.6 mm, and 0.8 mm for hole diameter 0.4 mm).

The pellets comprising blowing agent were then prefoamed in an EPS prefoamer to give foam beads of low density (from 15 to 25 g/L), and processed in an automatic EPS molding system at a gauge pressure of from 0.7 to 1.1 bar, to give moldings.

The disperse distribution of the polyethylene (pale regions) can be discerned in the transmission electron micrograph (TEM) of the minipellets comprising blowing agent (FIG. 1) and this subsequently contributes to elastification within the foam. The size of the PE domains of the blowing-agent-loaded minipellets here is of the order of from 200 to 1500 nm.

Coating components used were 70% by weight of glycerol tristearate (GTS) and 30% by weight of glycerol monostearate (GMS). The coating composition had a favorable effect on the fusion of the prefoamed foam beads to give the molding. Flexural strength could be increased to 250 and, respectively, 310 kPa, in comparison with 150 kPa for the moldings obtained from the uncoated pellets.

The small bead sizes of 0.8 mm exhibited an improvement in processability to give the molding, in terms of demolding times and behavior during charging to the mold. The surface of the molding was moreover more homogeneous than with beads of diameter 1.1 mm.

TABLE 1
Constitution of expandable polymer beads (EPS) in proportions by
weight, and properties of foam moldings

| Example | | |
|---|---|---|
| 1 | 2 | 3 |

Constitution of expandable beads

| | | | |
|---|---|---|---|
| Component A) | 69.8 | 71.1 | 76.9 |
| Component B1.1) | 17.8 | 9.4 | 7.5 |
| Component B2.1) | — | 8.7 | 4.7 |
| Component C1.1) | 1.6 | 1.6 | 1.6 |
| Component C2.1) | 1.6 | 1.6 | 0.9 |
| Component D) | 7.4 | 5.7 | 6.5 |
| Component E) | 1.9 | 1.9 | 1.9 |

Properties of foam molding

| | | | |
|---|---|---|---|
| Foam density [g/L] | 20.2 | 23.2 | 20.9 |
| Minimum density [g/L] | 18.0 | 19.8 | 17.0 |
| Compressive strength 10% [kPa] | 82 | 104 | 100 |
| Flexural strength [kPa] | 265 | 321 | 311 |
| Bending energy [Nm] | 4.5 | 5.8 | 4.6 |
| Compression set [%] | 34 | 33 | 32 |

### Examples 4 to 9

By analogy with the process according to example 1, blowing-agent-loaded polymer pellets were produced using the components and amounts stated in table 2. The blowing agent used comprised a mixture comprising 95% by weight of isopentane and 5% by weight of n-pentane. The pellets comprising blowing agent had a narrow particle size distribution (d′=1.2 mm, for hole diameter 0.65 mm).

The pellets comprising blowing agent were then prefoamed in an EPS prefoamer to give foam beads of low density (from 15 to 25 g/L), and processed in an automatic EPS molding system at a gauge pressure of from 0.9 to 1.4 bar, to give moldings.

Coating components used were 70% by weight of glycerol tristearate (GTS) and 30% by weight of glycerol monostearate (GMS). The coating composition had a favorable effect on the fusion of the prefoamed foam beads to give the molding.

The disperse distribution of the polyethylene (phase P1, pale regions), and the disperse distribution of the styrene-butadiene block copolymer (phase P2, dark regions) can be discerned in the transmission electron micrograph (TEM) of the minipellets comprising blowing agent (FIG. 2) and this subsequently contributes to elastification within the foam. The size of the PE domains of the blowing-agent-loaded minipellets here is of the order of from 200 to 1000 nm, and the size of the styrene-butadiene block copolymer domains is of the order of from 200 to 1500 nm.

TABLE 2
Constitution of expandable polymer beads (EPS) in
proportions by weight, and properties of foam moldings

| Example | | | | | |
|---|---|---|---|---|---|
| 4 | 5 | 6 | 7 | 8 | 9 |

Constitution of expandable beads

| | | | | | | |
|---|---|---|---|---|---|---|
| Component A) | 73.0 | 67.6 | 65.1 | 69.8 | 67.6 | 69.8 |
| Component B1.1) | 8.1 | 7.5 | 7.2 | 7.7 | 7.5 | 7.7 |
| Component B2.2) | 5.0 | 4.7 | 8.1 | 8.7 | 4.7 | 8.7 |
| Component C1.1 | | | | | 13.0 | 5.8 |
| Component C1.2 | 6.0 | 13.0 | 12.6 | 5.8 | | |
| Component C2.1 | | | | | 0.7 | 1.3 |
| Component C2.2 | 0.8 | 0.7 | 0.7 | 1.3 | | |
| Component D (95% of | 6.5 | 6.1 | 5.8 | 6.3 | 6.1 | 6.3 |
| isopentane, 5% | | | | | | |
| of n-pentane) | | | | | | |
| Component E) | 0.5 | 0.5 | 0.4 | 0.5 | 0.5 | 0.5 |

Properties of foam molding

| | | | | | | |
|---|---|---|---|---|---|---|
| Foam density [g/L] | 19.3 | 19.4 | 19.5 | 19.5 | 21.3 | 21.6 |
| Compressive strength 10% | 97 | 96 | 86 | 94 | 95 | 94 |
| [kPa] | | | | | | |
| Flexural strength [kPa] | 282 | 286 | 240 | 282 | 278 | 280 |
| Bending energy [Nm] | 4.8 | 5.8 | 5.1 | 5.5 | 5.7 | 5.4 |

### Examples 10 to 19

Components A, B, and C were melted at from 220 to 240° C./130 bar in a Leistritz ZSK 18 twin-screw extruder (see table 3). 7.5 parts of pentane S (20% of isopentane, 80% of n-pentane) were then injected as blowing agent (component D) into the polymer melt, and incorporated homogeneously into the polymer melt by way of two static mixers. The temperature was then reduced to from 180° to 185° C., by way of a cooler. One part of talc (component E) in the form of a masterbatch was then metered as nucleating agent into the blowing-agent-loaded main melt stream, by way of an ancillary extruder. After homogenization by way of two further static mixers, the melt was cooled to 140° C., and extruded through a heated pelletizing die (4 holes with 0.65 mm bore, and pelletizing die temperature of 280° C.). The polymer strap was chopped by means of an underwater pelletizer (12 bar of underwater pressure, 45° C. water temperature) giving blowing-agent-loaded minipellets having narrow particle size distribution (d′=1.1 mm).

The pellets comprising blowing agent were then prefoamed in an EPS prefoamer to give foam beads of low density (from 15 to 25 g/L), and processed in an automatic EPS molding system at a gauge pressure of from 0.9 to 1.4 bar, to give moldings.

Coating components used were 70% by weight of glycerol tristearate (GTS) and 30% by weight of glycerol monostearate (GMS). The coating composition had a favorable effect on the fusion of the prefoamed foam beads to give the molding.

TABLE 3
Constitution of the expandable polymer bead materials in proportions by weight, and properties of foam moldings

| Example | | | | | | | | | |
|---|---|---|---|---|---|---|---|---|---|
| 10 | 11 | 12 | 13 | 14 | 15 | 16 | 17 | 18 | 19 |

Constitution

| | | | | | | | | | | |
|---|---|---|---|---|---|---|---|---|---|---|
| Comp. A GPPS grade | 158K | 158K | 158K | 158K | 158K | 158K | 158K | 158K | 168N | 168N |
| Comp. A [% by wt.] | 84 | 78 | 73 | 65 | 61 | 73 | 61 | 50 | 73 | 61 |
| Comp. B1.1 [% by wt.] | 8 | 8 | 8 | 8 | 8 | 8 | 8 | 8 | 8 | 8 |
| Comp. B2.1 [% by wt.] | 5 | 5 | 5 | 5 | 5 | 5 | 5 | 5 | 5 | 5 |
| Comp. C1.3 [% by wt.] | | 6.25 | 11.50 | 18.75 | 22.75 | 6.25 | 12.5 | 18.75 | 11.5 | 12.5 |
| Comp. C2.1 [% by wt. | | | | | | 5.25 | 10.5 | 15.75 | | 10.5 |
| Comp. C1.1 [% by wt.] | 1.75 | 1.75 | 1.75 | 1.75 | 1.75 | 1.75 | 1.75 | 1.75 | 1.75 | 1.75 |
| Comp. D [% by wt.] | 7.5 | 7.5 | 7.5 | 7.5 | 7.5 | 7.5 | 7.5 | 7.5 | 7.5 | 7.5 |
| Comp. E [% by wt.] | 1 | 1 | 1 | 1 | 1 | 1 | 1 | 1 | 1 | 1 |

Properties of foam

| | | | | | | | | | | |
|---|---|---|---|---|---|---|---|---|---|---|
| Foam density [g/L] | 22.0 | 21.8 | 22.6 | 23.5 | 26.6 | 22.8 | 22.5 | 33.0 | 23.8 | 25.5 |
| Compressive strength 10% [kPa] | 103 | 103 | 100 | 110 | 106 | 112 | 109 | 116 | 130 | 116 |
| Flexural strength [kPa] | 301 | 287 | 293 | 308 | 313 | 299 | 301 | 330 | 322 | 330 |
| Bending energy [Nm] | 4.6 | 5.1 | 5.5 | 6.0 | 6.7 | 5.6 | 5.8 | 7.4 | 6.0 | 7.4 |
| Compression set [%] | 32 | 30 | 33 | 31 | 32 | 28 | 28 | 32 | 29 | 32 |

### Example 20

76.5% by weight of 158K polystyrene, 7.6% by weight of 1201XV LLDPE, 8.5% by weight of Exact® 210 EOC, and 1.2% by weight of Kraton® G1650 SEBS were melted at from 220 to 240° C./from 180 to 190 bar, in a Leistritz ZSK 18 twin-screw extruder 6.1% by weight of a mixture composed of 5% by weight of n-pentane:95% by weight of isopentane were then injected as blowing agent (component D), and incorporated homogeneously into the polymer melt by way of two static mixers. The temperature was then reduced to from 180° to 185° C. by way of a cooler. 0.5% by weight of talc in the form of a masterbatch was then metered as nucleating agent (component E) (see table 4a) into the blowing-agent-loaded main melt stream, by way of an ancillary extruder. After homogenization by way of two further static mixers, the melt was cooled to 155° C., and extruded through a heated pelletizing die (4 holes with 0.65 mm bore, and pelletizing die temperature of 280° C.). The polymer strap was chopped by means of an underwater pelletizer (12 bar of underwater pressure, 45° C. water temperature) giving blowing-agent-loaded minipellets having narrow particle size distribution (d′=1.25 mm).

### Examples 21 to 35

Examples 21 to 35 were carried out by analogy with example 20, using the amounts listed in tables 4a and 4b, and different constitutions of blowing agent.

The blowing agent retention experiments were carried out in a cylindrical zinc box with PE inlayer, the diameter and height of which were 23 cm and 20 cm, respectively. The minipellets comprising blowing agent, produced by way of extrusion, were charged to the PE bag, in such a way as to fill the zinc box completely, to the rim.

The closed containers were then placed into intermediate storage at room temperature (from 20 to 22° C.) for 16 weeks, and then opened in order to determine the blowing agent content of the minipellets, foamability to give minimum foam density, and blowing agent content after prefoaming of the minipellets to give minimum foam density. The blowing agent content of the minipellets was determined by back-weighing to constant weight after heating in the drying oven at 120° C.

Foamability was studied by treatment with unpressurized saturated steam in a steam box, by determining the minimum bulk density found, with the associated foaming time. The residual blowing agent content in the prefoamed beads was then measured by means of GC analysis (internal standard: n-hexane/dissolution in a mixture composed of 40 parts of toluene:60 parts of trichlorobenzene).

In order to reduce the time needed for the storage experiments and to render the differences clearer, the previously opened containers were placed in a fume cupboard at room temperature (from 20 to 22° C.) (suction rate 360 m³/h), and the blowing agent content of the minipellets and the foamability to give minimum foam density were again studied after 7 days and 14 days.

The examples show that higher proportions of isopentane improve capability to retain blowing agent after storage and can achieve relatively low minimum bulk densities.

TABLE 4a

| Examples | | | | | | | | |
|---|---|---|---|---|---|---|---|---|
| 20 | 21 | 22 | 23 | 24 | 25 | 26 | 27 | 28 |

Constitution

| | | | | | | | | | |
|---|---|---|---|---|---|---|---|---|---|
| Comp. A [% by wt.] | 76.5 | 72.8 | 72.8 | 67.2 | 67.2 | 63.2 | 63.2 | 71.3 | 67.5 |
| Comp. B1.1 [% by wt.] | 7.6 | 7.5 | 7.5 | 7.5 | 7.5 | 7.6 | 7.6 | 9.5 | 13.3 |
| Comp. B2.2 [% by wt.] | 8.5 | 12.3 | 12.3 | 12.3 | 12.3 | 8.5 | 8.5 | 4.7 | 4.7 |
| Comp. C1.2 [% by wt.] | 0.0 | 0.0 | 0.0 | 5.7 | 5.7 | 13.3 | 13.3 | 7.6 | 7.6 |
| Comp. C2.1 [% by wt.] | 1.2 | 1.2 | 1.2 | 1.2 | 1.2 | 1.2 | 1.2 | 0.8 | 0.8 |
| Comp. D [% by wt.] | 5.7 | 5.7 | 5.7 | 5.7 | 5.7 | 5.7 | 5.7 | 5.7 | 5.7 |
| Comp. D: n-/isopentane | 5/95 | 80/20 | 5/95 | 80/20 | 5/95 | 80/20 | 5/95 | 5/95 | 5/95 |
| Comp. E [% by wt.] | 0.5 | 0.5 | 0.5 | 0.5 | 0.5 | 0.5 | 0.5 | 0.5 | 0.5 |

16 days of closed storage

| | | | | | | | | | |
|---|---|---|---|---|---|---|---|---|---|
| Blowing agent content | 4.5 | 4.9 | 5.0 | 5.0 | 5.0 | 5.3 | 4.9 | 5.0 | 5.1 |
| [% by wt.] | | | | | | | | | |
| Minimum bulk density [g/L] | 20.0 | 31.3 | 22.7 | 23.3 | 20.0 | 26.3 | 20.8 | 18.5 | 18.5 |
| Residual blowing agent | 2.1 | 1.7 | 2.4 | 1.2 | 2.5 | 2.2 | 2.8 | 3.2 | 3.6 |
| content [% by wt.] | | | | | | | | | |
| Prefoaming time [s] | 1800 | 1800 | 900 | 1800 | 1200 | 300 | 600 | 720 | 720 |

+7 days of open storage

| | | | | | | | | | |
|---|---|---|---|---|---|---|---|---|---|
| Blowing agent content | 4.1 | 3.1 | 3.9 | 3.2 | 3.9 | 3.7 | 4.2 | 4.4 | 4.4 |
| [% by wt.] | | | | | | | | | |
| Minimum bulk density [g/L] | 22.7 | 220.0 | 38.5 | 100.0 | 33.3 | 38.5 | 23.8 | 18.5 | 20.8 |
| Prefoaming time [s] | 1800 | 1800 | 1800 | 1200 | 1800 | 1200 | 900 | 1800 | 1800 |
| Examples | 20 | 21 | 22 | 23 | 24 | 25 | 26 | 27 | 28 |

+14 days of open storage

| | | | | | | | | | |
|---|---|---|---|---|---|---|---|---|---|
| Blowing agent content | 3.9 | 2.7 | 3.5 | 2.8 | 3.5 | 3.3 | 3.9 | 4.3 | 4.3 |
| [% by wt.] | | | | | | | | | |
| Minimum bulk density [g/L] | 23.8 | 220.0 | 50.0 | 270.0 | 45.5 | 50.0 | 27.8 | 20.8 | 21.7 |
| Prefoaming time [s] | 1800 | 1800 | 1800 | 1200 | 1800 | 1200 | 900 | 1800 | 1800 |

TABLE 4b

| Example | | | | | | |
|---|---|---|---|---|---|---|
| 29 | 30 | 31 | 32 | 33 | 34 | 35 |

Constitution

| | | | | | | | |
|---|---|---|---|---|---|---|---|
| Comp. A [% by wt.] | 70.9 | 70.9 | 70.9 | 67.2 | 67.5 | 67.5 | 67.2 |
| Comp. B1.1 [% by wt.] | 7.5 | 7.5 | 7.5 | 7.5 | 7.6 | 7.6 | 7.5 |
| Comp. B2.2 [% by wt.] | 8.5 | 8.5 | 8.5 | 4.7 | 4.7 | 4.7 | 4.7 |
| Comp. C1.2 [% by wt.] | 5.7 | 5.7 | 5.7 | 13.2 | 13.3 | 13.3 | 13.2 |
| Comp. C2.1 [% by wt.] | 1.2 | 1.2 | 1.2 | 0.8 | 0.8 | 0.8 | 0.8 |
| Comp. D [% by wt.] | 5.7 | 5.7 | 5.7 | 6.1 | 5.7 | 5.7 | 6.1 |
| Comp. D: n-/isopentane | 80/20 | 40/60 | 5/95 | 80/20 | 80/20 | 40/60 | 5/95 |
| Comp. E [% by wt.] | 0.5 | 0.5 | 0.5 | 0.5 | 0.5 | 0.5 | 0.5 |

16 days of closed storage

| | | | | | | | |
|---|---|---|---|---|---|---|---|
| Blowing agent content | 5.1 | 5.2 | 5.3 | 5.7 | 5.6 | 5.7 | 5.6 |
| [% by wt.] | | | | | | | |
| Minimum bulk | 22.7 | 20.0 | 20.0 | 25.0 | 25.0 | 17.9 | 17.9 |
| density [g/L] | | | | | | | |
| Residual blowing agent | 1.4 | 2.4 | 3.4 | 2.4 | 2.1 | 2.7 | 3.3 |
| content [% by weight] | | | | | | | |
| Prefoaming time [s] | 420 | 600 | 720 | 150 | 150 | 180 | 180 |

+7 days of open storage

| | | | | | | | |
|---|---|---|---|---|---|---|---|
| Blowing agent content | 3.5 | 3.7 | 4.5 | 4.1 | 3.8 | 3.8 | 4.5 |
| [% by weight] | | | | | | | |
| Minimum bulk | 33.8 | 25.0 | 20.2 | 27.8 | 31.3 | 21.7 | 20.0 |
| density [g/L] | | | | | | | |
| Prefoaming time [s] | 2700 | 1620 | 1200 | 600 | 600 | 900 | 300 |

+14 days of open storage

| | | | | | | | |
|---|---|---|---|---|---|---|---|
| Blowing agent content | 3.0 | 3.3 | 4.2 | 3.8 | 3.4 | 3.5 | 4.2 |
| [% by weight] | | | | | | | |
| Minimum bulk | 50.0 | 42.9 | 22.1 | 42.9 | 38.5 | 26.3 | 23.7 |
| density [g/L] | | | | | | | |
| Prefoaming time [s] | 1800 | 1800 | 1800 | 600 | 1200 | 1200 | 360 |

### Examples 36 to 55

### Production of Moldings Composed of Foam Beads P1 and P2

Production of Foam Beads P1:

Components A) to C) were melted at from 240 to 260° C./140 bar in a Leistritz ZE 40 twin-screw extruder, and talc was admixed as nucleating agent (component E) (see table 1). The blowing agent mixture composed of 95% by weight of isopentane and 5% by weight of n-pentane (component D) was then injected into the polymer melt and homogeneously incorporated into the polymer melt by way of two static mixers. The temperature was then reduced to from 180° to 195° C., by way of a cooler. After further homogenization by way of two further static mixers, the polymer melt was injected at from 200 to 220 bar, at 50 kg/h, through a pelletizing die whose temperature was controlled to from 240 to 260° C. (hole diameter was 0.6 mm, with 7 cavity systems×7 holes, or 0.4 mm hole diameter with 7 cavity systems×10 holes). The polymer strand was chopped by means of underwater pelletizer system (11-10 bar of underwater pressure at a water temperature of from 40° C. to 50° C.), giving minipellets loaded with blowing agent and having narrow particle size distribution (d′=1.2 mm for hole diameter of 0.65 mm).

Coating components used were 70% by weight of glycerol tristearate (GTS) and 30% by weight of glycerol monostearate (GMS). The coating composition had a favorable effect on the fusion of the prefoamed foam beads to give the molding.

TABLE 5
Constitution of expandable polymer bead materials
(EPS) in proportions by weight for production
of foam beads P1.1, P1.2, and P1.3

| | Example [% by wt.] | | | | | | |
|---|---|---|---|---|---|---|---|
| | Comp. | Comp. | Comp. | Comp. | Comp. | Comp. | Comp. |
| | A | B1.1 | B2.2 | C2.2 | C1.2 | E | D |
| P1.1 | 67.2 | 7.5 | 4.7 | 0.7 | 13.2 | 0.5 | 6.1 |
| P1.2 | 67.9 | 7.5 | 4.7 | 0 | 13.2 | 0.5 | 6.1 |
| P1.3 | 81.1 | 7.5 | 4.7 | 0 | 0 | 0.5 | 6.1 |
| comp | | | | | | | |

The disperse distribution of the polyethylene (phase 1, pale regions), and the disperse distribution of the styrene-butadiene block copolymer (phase 2, dark regions) can be discerned in a transmission electron micrograph (TEM) of the minipellets comprising blowing agent and this subsequently contributes to elastification within the foam. The size of the PE domains of the blowing-agent-loaded minipellets here is of the order of from 200 to 1000 nm, and the size of the styrene-butadiene block copolymer domains is of the order of from 200 to 1500 nm.

The pellets comprising blowing agent were prefoamed in an EPS prefoamer to give foam beads of low density (17.7 kg/m³).

Foam Beads P2:

Neopor® X 5300 (expandable polystyrene from BASF SE, comprising graphite) was prefoamed to a density of 16.1 kg/m³.

Foamed beads P1 and P2 were mixed in the quantitative proportion according to tables 6 to 9, and processed in an automatic EPS molding machine at a gauge pressure of 1.1 bar, to give moldings.

Various mechanical measurements were made on the moldings, in order to demonstrate the elastification of the foam. Marked elastification is observed in the examples of the invention in comparison with straight EPS, discernible from very high resilience. Compressive strength was determined to DIN-EN 826 for 10% compression, flexural strength was determined to DIN-EN 12089. Bending energy was determined from the values measured for flexural strength.

Example 40 comp is a comparative experiment.

TABLE 6
Properties of molded foams composed of
different proportions of foam beads P1.1:

| | Example | | | | |
|---|---|---|---|---|---|
| | 36 | 37 | 38 | 39 | 40 comp |
| P1.1 | 100% | 60% | 40% | 20% | 0% |
| P2 | 0% | 40% | 60% | 80% | 100% |
| Density [g/l] | 17.7 | 17.3 | 16.8 | 16.6 | 16.1 |
| Bending energy [Nm] | 5.4 | 4.2 | 3.7 | 3.1 | 2.7 |
| Flexural strength [kPa] | 250.7 | 247.9 | 243.5 | 239.3 | 228.3 |
| Specific energy | 0.3 | 0.2 | 0.2 | 0.2 | 0.2 |
| [Nm/(kg/m³)] | | | | | |
| Specific force | 35.0 | 35.1 | 35.8 | 35.3 | 35.2 |
| [N/(kg/m³)] | | | | | |

The examples show that the foam beads P2 can be mixed with the foam beads P1 used according to the invention, over wide ranges. This method can be used for targeted setting of mechanical properties, such as bending energy.

TABLE 7
Bending energy [Nm] of molded foams
composed of various proportions of foam beads P1.1

| | Example | | | | |
|---|---|---|---|---|---|
| | 41 | 42 | 43 | 44 | 45 |
| Proportion of P2 | 0 | 20 | 40 | 60 | 80 |
| [% by wt.] | | | | | |
| Proportion P1.1 | 95 | 80 | 60 | 40 | 20 |
| [% by wt.] | | | | | |
| Bending energy [Nm] | 5.5 | 5.0 | 4.2 | 3.7 | 3.1 |

TABLE 8
Bending energy [Nm] of molded foams composed
of various proportions of foam beads P1.2

| | Example | | | | |
|---|---|---|---|---|---|
| | 46 | 47 | 48 | 49 | 50 |
| Proportion of P2 | 0 | 20 | 40 | 60 | 80 |
| [% by weight] | | | | | |
| Proportion of P1.2 | 95 | 80 | 60 | 40 | 20 |
| [% by weight] | | | | | |
| Bending energy | 4.2 | 4.0 | 3.5 | 3.3 | 3.2 |
| [Nm] | | | | | |

TABLE 9
Bending energy [Nm] of molded foams composed
of various proportions of foam beads P1.3 V

| | Example | | | | |
|---|---|---|---|---|---|
| | 51 | 52 | 53 | 54 | 55 |
| Proportion of P2 | 0 | 20 | 40 | 60 | 80 |
| [% by weight] | | | | | |
| Proportion of P1.3 | 95 | 80 | 60 | 40 | 20 |
| V [% by weight] | | | | | |
| Bending energy | 3.1 | 2.8 | 2.9 | 3.0 | 2.7 |
| [Nm] | | | | | |

1. An expandable, thermoplastic polymer bead material, comprising
A) from 45 to 97.8 percent by weight of a styrene polymer,
B1) from 1 to 45 percent by weight of a polyolefin whose melting point is in the range from 105 to 140° C.
B2) from 0 to 25 percent by weight of a polyolefin whose melting point is below 105° C.,
C1) from 0.1 to 25 percent by weight of a styrene-butadiene or styrene-isoprene block copolymer,
C2) from 0.1 to 10 percent by weight of a styrene-ethylene-butylene block copolymer,
D) from 1 to 15 percent by weight of a blowing agent,
E) from 0 to 5 percent by weight of a nucleating agent
where the entirety of A) to E) gives 100% by weight.

2. The expandable, thermoplastic polymer bead material according to claim 1, which comprises
A) from 55 to 78.1 percent by weight of a styrene polymer,
B1) from 4 to 25 percent by weight of a polyolefin whose melting point is in the range from 105 to 140° C.,
B2) from 1 to 15 percent by weight of a polyolefin whose melting point is below 105° C.
C1) from 6 to 15 percent by weight of a styrene-butadiene or styrene-isoprene block copolymer,
C2) from 1 to 5 percent by weight of a styrene-ethylene-butylene block copolymer,
D) from 3 to 10 percent by weight of a blowing agent,
E) from 0.3 to 3 percent by weight of a nucleating agent
where the entirety of A) to E) gives 100% by weight.

3. The expandable, thermoplastic polymer bead material according to claim 1, which comprises standard polystyrene (GPPS) as styrene polymer A).

4. The expandable, thermoplastic polymer bead material according to claim 1, which comprises polyethylene as polyolefin B1).

5. The expandable, thermoplastic polymer bead material according to claim 1, which comprises a copolymer composed of ethylene and octene as polyolefin B2).

6. The expandable, thermoplastic polymer bead material according to claim 1, which uses, as component C1, a block copolymer whose weight-average molar mass M_{w} is at least 100 000 g/mol, comprising
a) at least one block S composed of from 95 to 100% by weight of vinylaromatic monomers and of from 0 to 5% by weight of dienes, and
b) at least one copolymer block (S/B)_{A} composed of from 63 to 80% by weight of vinylaromatic monomers and of from 20 to 37% by weight of dienes, with a glass transition temperature Tg_{A} in the range from 5 to 30° C.,
where the proportion by weight of the entirety of all of the blocks S is in the range from 50 to 70% by weight, based on the block copolymer.

7. The expandable, thermoplastic polymer bead material according to claim 1, wherein the block copolymer C1 has a linear structure having the block sequence S₁-(S/B)_{A}-S₂-(S/B)_{A}-S₃, where each of S₁, S₂ and S₃ is a block S.

8. The expandable, thermoplastic polymer bead material according to claim 1, wherein the total of the proportions of components C1 and C2 is in the range from 6.8 to 18 percent by weight.

9. The expandable, thermoplastic polymer bead material according to claim 1, wherein the ratio by weight of the entirety composed of components B1 and B2 to C2 is in the range from 5 to 70.

10. The expandable, thermoplastic polymer bead material according to claim 4, wherein the ratio by weight of components C1 to C2 is in the range from 2 to 5.

11. The expandable, thermoplastic polymer bead material according to claim 1, which comprises, as blowing agent, a mixture composed of C₃-C₈ hydrocarbons with a proportion of from 25 to 100 percent by weight, based on the blowing agent, of isopentane or cyclopentane.

12. The expandable, thermoplastic polymer head material according to claim 1, which comprises at least one disperse phase with average diameter in the range from 1 to 1500 nm.

13. The expandable, thermoplastic polymer bead material according to claim 12, which is composed of a multiphase polymer mixture comprising blowing agent and having at least one continuous phase and at least two disperse phases P1 and P2 distributed within the continuous phase, where
a) the continuous phase consists essentially of component A,
b) the first disperse phase P1 consists essentially of components B1 and B2, and
c) the second disperse phase P2 consists essentially of component C1.

14. The expandable, thermoplastic polymer bead material according to claim 1, which comprises a coating, comprising a glycerol stearate.

15. A process for the production of expandable, thermoplastic polymer bead materials according to claim 1, which comprises
a) producing a polymer melt with a continuous and a disperse phase via mixing of components A to C and, optionally, E,
b) impregnating this polymer melt with a blowing agent,
c) and pelletizing to give expandable thermoplastic polymer bead material, via underwater pelletization at a pressure of from 1.5 to 10 bar.

16. A process for the production of expandable, thermoplastic polymer bead materials according to claim 1, which comprises
a) producing a polymer melt with a continuous and a disperse phase via mixing of components A to C and, optionally, E,
b) pelletizing this polymer melt, and then impregnating it in an aqueous phase under pressure and at an elevated temperature with a blowing agent D) to give expandable thermoplastic polymer bead material.

17. The process according to claim 15, wherein, in stage b), from 1 to 10 percent by weight, based on the polymer mixture, of a C₃-C₈ hydrocarbon are used as blowing agent.

18. A process for the production of molded foams via sintering of a mixture comprising foam beads P1 and P2 composed of different thermoplastic polymers or polymer mixtures, which comprises obtaining the foam beads P1 via prefoaming of expandable, thermoplastic polymer bead materials according to claim 1.

19. The process according to claim 18, wherein expanded polypropylene (EPP) or prefoamed, expandable polystyrene (EPS) is used as foam beads P2.

20. The process according to claim 18, wherein from 10 to 99% by weight of foam beads P1 and from 1 to 90% by weight of foam beads P2 are used for the production of the molded foams.
